(19) United States
(12) Patent Application Publication
(10) Pub. No.: US 2018/0183646 A1
(43) Pub. Date: Jun. 28, 2018

(54) METHOD AND DEVICE FOR FRAME SYNCHRONIZATION IN COMMUNICATION SYSTEMS

(71) Applicant: FUNDACIO CENTRE TECNOLOGIC DE TELECOMUNICACIONS DE CATALUNYA, Castelldefels (Barcelona) (ES)

(72) Inventors: Stephan PFLETSCHINGER, Castelldefels (Barcelona) (ES); Monica NAVARRO RODERO, Castelldefels (Barcelona) (ES); Pau CLOSAS GOMEZ, Castelldefels (Barcelona) (ES)

(21) Appl. No.: 15/579,757

(22) PCT Filed: Jun. 2, 2016
(86) PCT No.: PCT/EP2016/062468

§ 371 Date: Dec. 5, 2017

(30) Foreign Application Priority Data
Jun. 5, 2015 (ES) P 201530789

(51) Int. Cl. H04L 27/26; H04L 7/04

(52) U.S. Cl. CPC H04L 27/2692; H04L 7/041; H04L 27/2671; H04L 27/2675; H04L 27/2656

(57) ABSTRACT

A device and method for frame synchronizing in a receiver of a communication system. The frame, transmitted in a signal out of a J-PSK constellation, J≥2, is received including a data sequence, a synchronization marker preceding the data sequence and an acquisition sequence preceding the synchronization marker, and wherein the synchronization marker is searched by using the acquisition sequence. In addition, a sliding observation window with an extended length, being M≥N can be used. Also, a buffer-based peak detection to find the synchronization marker in a buffered span of received symbols can be used, in addition to list decoding in order to exploit the error detection capability of the channel decoding in the receiver for false alarm detection.

### FIELD OF THE INVENTION

The present invention has its application within the telecommunication sector, especially, deals with the field of frame synchronizers in digital communication systems.

More specifically, the present invention proposes a method and a receiver device to optimize frame synchronization in (wireless or wired) communication systems, especially in deep-space communications.

### BACKGROUND OF THE INVENTION

In many digital communication systems, the transmitted data is organized in frames, wherein the beginning of the data, which is of interest to the receiver, is indicated by a known synchronization (sync) marker. Before the sync marker, another sequence with certain known characteristics is transmitted. This sync marker is a sequence of known symbols which directly precedes the data and helps the receiver to determine the beginning of the data.

Frame synchronization is therefore an important receiver function which has to be performed before decoding of the transmitted data can begin. It consists in finding the position of the known synchronization marker in the incoming symbol stream. Common engineering practise is to compute the correlation of a part of the received sequence with the known sync marker at each symbol position and compare it to a threshold. This approach is optimum for the binary symmetric channel, but not for Additive White Gaussian Noise (AWGN) or fading channels.

For example, in the case of a periodically inserted sync marker, J. L. Massey disclosed an optimum frame synchronizer in “Optimum frame synchronization”, IEEE Trans. Commun., vol. 20, no. 2, pp. 115-119, April 1972. For a single sync marker, M. Chiani presented the solution “Noncoherent frame synchronization,” IEEE Trans. Commun., vol. 58, no. 5, pp. 1536-1545, May 2010, which describes the principles of hypothesis testing disclosed in “Statistical Inference”, Casella et al., Duxbury Resource Center, June 2001, for frame synchronization in the AWGN channel, summarized as follows: It is considered a communication system in which a transmitter sends BPSK-modulated data frames, which are preceded by a sync marker. The sync marker consists of a known sequence of N BPSK symbols. The task of the frame synchronizer is to find this sync marker in a stream of received noisy symbols. The typically applied procedure takes the last N received symbols r=[r₁, r₂, . . . r_{N}] and compares them to the known sync marker and then makes a decision according to two possible hypotheses, H₀ or H₁:
H₀: r does not correspond to the sync word
H₁: r corresponds to the sync word

The corresponding decisions are denoted as D₀ or D₁. The optimum approach for this hypothesis testing problem is described in “On sequential frame synchronization in AWGN channels” M. Chiani et al., IEEE Trans. Commun., vol. 54, no. 2, pp. 339-348, February 2006.

This optimum approach is given by the likelihood ratio test (LRT) disclosed in “Statistical Inference” by Casella et al.:

$$Λ ( r ) {△}^{} \frac{p ( r \vert {ℋ}_{1} )}{p ( r \vert {ℋ}_{0} )} \frac{{{𝒟}_{1}}_{>}}{{{𝒟}_{0}}^{<}} λ \qquad ( equation 1 )$$

where r=[r₁, r₂, . . . , r_{N}] denotes the received sequence within an observation window. In other words, this approach by M. Chiani et al. uses a sliding observation window of the same length as the sync marker, taking N symbols out of the received noisy symbols stream. Then, a metric Λ(r) is computed according to equation 1 and its value compared to a threshold. If the computed metric Λ(r) value exceeds this threshold, the receiver declares the sequence in the observation window r=[r₁, r₂, . . . , r_{N}] to be the sync marker.

For binary signaling over an AWGN channel, the received symbols can be given by the expression:

rₙ=xₙ+wₙ, xₙε{−1,1} (equation 2)

where xₙε{−1, 1} denote the transmitted BPSK symbols and rₙ is the received signal. The noise wₙ is assumed to be normal distributed by the probability density function or PDF (p_{w}) with zero mean and variance N₀/2 by:

$${p}_{w} ( w ) = \frac{1}{\sqrt{π {N}_{0}}} exp ( - \frac{{w}^{2}}{{N}_{0}} ) \qquad ( equation 3 )$$

where w=└w₁, . . . , w_{N}┘ is AWGN

Denoting the known sync marker by s=[s₁, s₂, . . . , s_{N}] with sₙε{−1, 1}, while d=[d₁, d₂, . . . , d_{N}] with dₙε{−1,1} denotes a random data sequence, the two hypotheses can be formulated as:

H₀:r=d+w

H₁:r=s+w (equation 4)

As shown in the aforementioned “On sequential frame synchronization in AWGN channels”, this leads to a “Massey-Chiani (MC)” metric Λ_{MC,1}(r) defined as:

$${Λ}_{MC , 1} ( r ) = \frac{2}{{N}_{0}} {\sum }_{n = 1}^{N} {s}_{n} {r}_{n} - ln cosh ( \frac{2}{{N}_{0}} {r}_{n} ) \qquad ( equation 5 )$$

This approach is valid for any reasonably designed sync marker but neglects the “mixed data” case in which the observation window r contains both data and a part of the sync marker. Note that the Massey-Chiani metric Λ_{MC,1} is equivalent to equations described by Massey in the aforementioned “Optimum frame synchronization” (page 116) on frame synchronization for the case of a periodically repeated sync marker, which has also been noted in equation 12 of “On sequential frame synchronization in AWGN channels” by Chiani. For this reason, Λ_{MC,1} is referred to as the Massey-Chiani (MC) metric.

Assuming that timing, frequency and phase synchronization have been accomplished perfectly, the unknown sign of the received BPSK symbols should be accounted for. Even with perfect timing, frequency and phase synchronization, an ambiguity about the polarity of the received symbols rₙ remains.

As a reference, the MC metric for the BI-AWGN channel with sign ambiguity can be modeled by:

rₙ=h·xₙ+wₙ, wₙ˜ [symbol] (0, N₀/2) (equation 6)

where hε{−1,1}, P[h=−1]=P[h=1] accounts for the unknown sign and this coefficient is constant but unknown for each synchronization attempt. Hence, for this case, the two hypotheses can rewriten as:

H₀:r=h·d+w

H₁:r=h·s+w (equation 7)

where the coefficient h can be omitted for the null hypothesis, since it does not change the statistics of the random data sequence.

With the signal modelled by equation 6, the likelihood of the null hypothesis can be obtained with the same conditional likelihood as if the sign was known:

$$\begin{matrix}p ( r \vert {H}_{0} ) = {\prod }_{n = 1}^{N} \frac{1}{2} ( p ( {r}_{n} \vert {d}_{n} = - 1 ) + p ( {r}_{n} \vert {d}_{n} = 1 ) ) \\ = {K}_{N} ( r ) {\prod }_{n = 1}^{N} cosh ( {\tilde{r}}_{n} )\end{matrix}$$

where we define

$${K}_{N} ( r ) {=}^{△} {\prod }_{n = 1}^{N} \frac{1}{\sqrt{π {N}_{0}}} exp ( - \frac{{r}_{n}^{2} + 1}{{N}_{0}} ) and {\tilde{r}}_{n} {=}^{△} \frac{2}{{N}_{0 \_}} {r}_{n} .$$

For the other hypothesis, we find

$$p ( r \vert {H}_{1} ) = \frac{1}{2} ( p ( r \vert x = - s ) + p ( r \vert x = s ) ) = \frac{1}{2} ( {\prod }_{n = 1}^{N} p ( {r}_{n} \vert {x}_{n} = - {s}_{n} ) + {\prod }_{n = 1}^{N} p ( {r}_{n} \vert {x}_{n} = {s}_{n} ) ) = {K}_{N} ( r ) \cdot cosh ( \frac{2}{{N}_{0}} {\sum }_{n = 1}^{N} {r}_{n} {s}_{n} ) = {K}_{N} ( r ) \cdot cosh ( \tilde{r} {s}^{T} )$$

This leads to the MC metric for sign ambiguity:

$${Λ}_{MC , 2} ( r ) = ln cosh ( \tilde{r} {s}^{T} ) - {\sum }_{n = 1}^{N} ln cosh ( {\tilde{r}}_{n} ) \qquad ( equation 8 )$$

Following the same approach as in “On sequential frame synchronization in AWGN channels” by Chiani, the generalized LRT metric Λ_{G-LRT(r)} can also be obtained as:

$${Λ}_{G - LRT} ( r ) = ln cosh ( \tilde{r} {s}^{T} ) - {\sum }_{n = 1}^{N} \vert {\tilde{r}}_{n} \vert \qquad ( equation 9 )$$

And using the approximation lncos h(x)≈|x|−ln(2), the simplified Λ_{S-LRT(r)} can be derived from both equation 8 and equation 9:

$${Λ}_{S - LRT} ( r ) = \vert {rs}^{T} \vert - {\sum }_{n = 1}^{N} \vert {r}_{n} \vert \qquad ( equation 10 )$$

This expression appeared also in “Noncoherent frame synchronization” by Chiani (page 1539, equation 25) as a heuristic test for the non-coherent receiver, in which the phase is uniformly distributed in [−π,π].

On the other hand, the correlation of the received samples with the known sync marker is still a popular metric despite its sub-optimality and the only marginally lower computational complexity, compared to e.g. equation 10. Since these metrics do not have a rigorous theoretical justification, the correlation to the received sequence and its inverse is applied and the maximum of both as the correlation metric for the binary-input AWGN channel with sign ambiguity is defined.

For a hard correlation metric Λ_{HC}(r), a hard decision is made on each bit and then it is correlated with the know sync marker:

$$\begin{matrix}{Λ}_{HC} ( r ) {=}^{△} \frac{1}{2} max \{ sgn ( r ) {s}^{T} , - sgn ( r ) {s}^{T} \} \\ = \frac{1}{2} \vert sgn ( r ) {s}^{T} \vert ∈ \{ 0 , 1 , … , \frac{N}{2} \}\end{matrix} \qquad ( equation 11 )$$

A factor 1/2 is introduced in equation 11 in order to obtain a range of contiguous integers as possible values for this metric. Naturally, any other constant factor (or monotonic function) can be applied as well.

In analogy to correlating with the hard-decided signal, another natural metric is the soft correlation metric Λ_{SC(r)}, which applies the correlation directly on the noisy BPSK signal:

Λ_{SC}(r) [symbol] 1/2|rs^{T}| (equation 12)

The factor 1/2 is again introduced for convenience and comparability with equation 11. Note that, in contrast to decoding, there is no reason why soft correlation should be superior to hard correlation.

While the correlation metric is optimum on the binary symmetric channel, for the AWGN channel both correlations are only heuristic metrics.

Moreover, in deep-space telecommand communication systems, it is expected to operate at low Signal-to-Noise-Ratio (SNR) in future missions, e.g. for direct transmissions to Mars. In these cases, the current approach for frame synchronization has poor performance.

Therefore, there is a need in the state of the art for more efficient ways to deal with frame synchronization in digital communication systems which allow significant performance enhancement with marginal implementation complexity with respect to the state-of-art solutions.

### SUMMARY OF THE INVENTION

The present invention solves the aforementioned problems and overcomes previously explained state-of-art work limitations by providing a method and device of frame synchronization applicable to frame formats in which the known synchronization marker (sync marker) is preceded by an acquisition sequence. This is the case for deep-space telecommand communication and many digital communications systems.

The invention can be applied to channels with soft output, i.e. with a received signal which is a real or complex number or a quantized version of a real or complex number, e.g., a binary-input AWGN channel. The invention can be easily extended from BPSK to higher-order J-PSK signalling, J≥2.

The present invention takes into account the sign ambiguity of the received symbols and the knowledge of the receiver about the acquisition sequence preceding the sync marker. In a possible embodiment, for the common case that the sync marker is followed by encoded data, the present invention exploits the error detection capability of the channel decoder and applies a list decoding approach for frame synchronization. In another possible embodiment, the present invention uses an extended sliding observation window at the receiving side and the knowledge properties of the acquisition sequence to obtain the appropriate decision metric for frame synchronization. The most common examples of acquisition sequences are constant and alternating sequences but any periodic sequence with a short period can also be considered.

The proposed invention can be applied in systems of telecommand for deep-space communications, but it is not limited to this industry. The invention has application to most digital communication systems, including mobile wireless as well as wired transmissions.

A first aspect of the present invention refers to a method for frame synchronizing in communication systems, wherein the frame comprises a data sequence, a syncronization marker preceding the data sequence and an acquisition sequence preceding the syncronization marker, the method using the acquisition sequence to search for the syncronization marker within the frame.

In a second aspect of the present invention, a device for for frame synchronization at the receiving side in telecommunication systems is disclosed, the frame synchronizer device further comprising means for implementing the method described before.

In a last aspect of the present invention, a computer program is disclosed, comprising computer program code means adapted to perform the steps of the described method, when said program is run on processing means of a receiving device, said processing means being a computer, a digital signal processor, a field-programmable gate array (FPGA), an application-specific integrated circuit (ASIC), a micro-processor, a micro-controller, or any other form of programmable hardware.

The method in accordance with the above described aspects of the invention has a number of advantages with respect to prior art, which can be summarized as follows:
The proposed invention allows savings in transmitted energy per symbol, which is crucial in space missions requiring low SNR operation.
In terms of frame synchronization errors, the present invention performs significantly better than the prior art solutions. Therefore, the reliability of the proposed receiver device is increased and, furthemore, the device is robust since it does not require signal-to-noise ratio (SNR) estimation at the receiving side and does not need maintenance.
The invention can be implemented in a space-qualified receiver, together with the other receiver functions, without requiring additional hardware or processing capabilities, besides those already available in a state-of-the-art receiver.
The invention achieves performance gains thanks to the presence of the acquisition sequence, but the proposed method works even if the acquisition sequence is not present (in this latter case, with similar performance to other existing frame synchronization methods).

These and other advantages will be apparent in the light of the detailed description of the invention.

### DESCRIPTION OF THE DRAWINGS

For the purpose of aiding the understanding of the characteristics of the invention, according to a preferred practical embodiment thereof and in order to complement this description, the following figures are attached as an integral part thereof, having an illustrative and non-limiting character:

FIG. 1 shows the structure of a frame transmitted in a communication system, as known in prior-art.

FIG. 2 shows the structure of a frame to which the invention can be applied.

FIG. 3 shows the structure and position of an extended sliding observation window with respect to the frame, in accordance with a preferred embodiment of the invention.

FIG. 4 shows probabilities of missed detection, false alarm and frame synchronization error for the soft correlation and the LRT-A metrics with a length of extended observation window, in accordance with a possible embodiment of the invention.

FIG. 5 shows the frame synchronization error at a fixed signal-to-noise ratio, for hard correlation, soft correlation, the Massey-Chiani metric and LRT-A metrics, and for different lengths of the extended observation window, in accordance with another possible embodiment of the invention.

FIG. 6 shows the frame synchronization error for different signal-to-noise ratios, for hard correlation, soft correlation, the Massey-Chiani metric and LRT-A metrics, and for different lengths of the extended observation window, in accordance with another possible embodiment of the invention.

FIG. 7 shows the frame and buffer structure for peak detection, in accordance with a possible embodiment of the invention.

FIG. 8 shows a block diagram of the receiver architecture using frame synchronization, in accordance with a possible embodiment of the invention.

FIG. 9 shows a flow chart for frame synchronization using peak detection, in accordance with a possible embodiment of the invention.

FIG. 10 shows the frame synchronization error as a function of signal-to-noise, in accordance with a further possible embodiment of the invention, using multiple peak detection on a long observation window.

### PREFERRED EMBODIMENT OF THE INVENTION

The matters defined in this detailed description are provided to assist in a comprehensive understanding of the invention. Accordingly, those of ordinary skill in the art will recognize that variation changes and modifications of the embodiments described herein can be made without departing from the scope and spirit of the invention. Also, description of well-known functions and elements are omitted for clarity and conciseness.

Of course, the embodiments of the invention can be implemented in a variety of architectural platforms, operating and server systems, devices, systems, or applications. Any particular architectural layout or implementation presented herein is provided for purposes of illustration and comprehension only and is not intended to limit aspects of the invention.

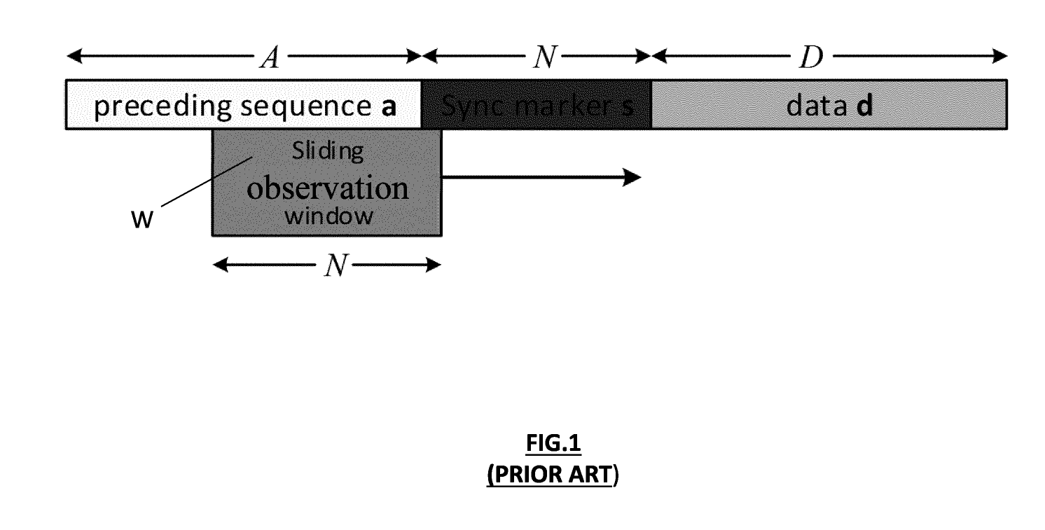

FIG. 1 illustrates transmitted data in a frame whose structure consists of: a sync marker (s) which is a known word of length N and indicates the beginning of the data (d) transmitted within a block of length D. The sync marker (s) can be denoted by s=[s₁, s₂, . . . s_{N}]ε{−1, 1}^{N}. Before the sync marker (s), there is preceding sequence (a) with a known structure of length A, the length of the preceding sequence (a) being generally not known by the receiver. The preceding sequence (a) is typically used for time and frequency acquisition. For this reason, in the following and in the context of the invention, this sequence is called the acquisition sequence (a) and is denoted by a=[a₁, a₂, . . . , a_{A}].

Some possible and relevant examples for the acquisition sequence (a) are:
A sequence of alternating symbols: aₙ=(−1)ⁿε{−1, 1}
A constant signal: aₙ=a₀ε [symbol] , including the case a₀=0

In prior art, a sliding observation window (W) of the same length N as the sync marker (s) takes N symbols out of the received noisy symbols stream to compute the metric Λ(r) which is compared to a pre-defined threshold.

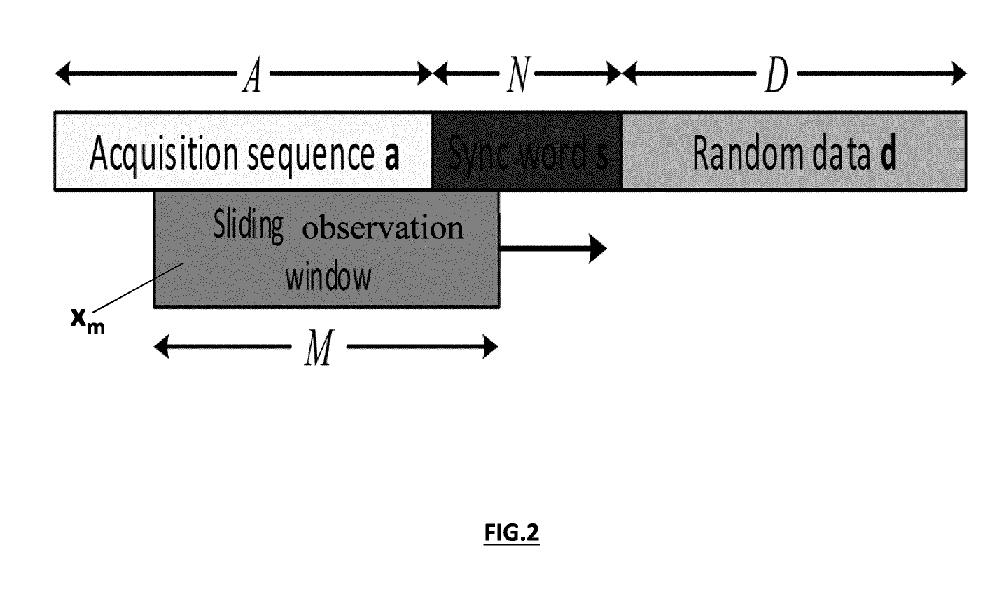

It is within the context of the invention, that various embodiments are now presented with reference to the FIGS. 2-10.

FIG. 2 presents an example of transmitted frame to be synchronized at the receiving side of a digital communication system in accordance with a possible embodiment of the invention. The formulation used in the following holds for all the above-mentioned three cases of a possible acquisition sequence (a): a sequence of alternating symbols, a void signal or a constant signal.

In order to better exploit the known properties of the preceding acquisition sequence (a), the use of an extended sliding window (xₘ) is proposed to compute a metric for frame synchronization. The sliding observation window (xₘ) is extended to a length M≥N, i.e., the observation window (xₘ) may be longer than the sync marker, as depicted in FIG. 2.

The entire noiseless sequence can be denoted by x=[h₁a, h₂s,d] (equation 13), where d denotes an unknown data sequence.

The random coefficients h₁, h₂ ε{−1, 1} model the sign ambiguity of the received signal and the sign ambiguity of the acquisition sequence (a). Although it is assumed that at the receiving side, the sign ambiguity is the same for the entire received sequence, the two factors h₁ and h₂ are needed to account also for the uncertainty on whether the acquisition sequence (a) ends with a binary value equal to −1 or +1. This uncertainty could be easily removed at the transmitter side.

A noiseless extended sliding observation window (xₘ) at position m is defined as xₘ [symbol] [h₁·a_{M+1-m}·h₂·sₘ₋₁] (equation 14), where m=1, 2, . . . , N+1.

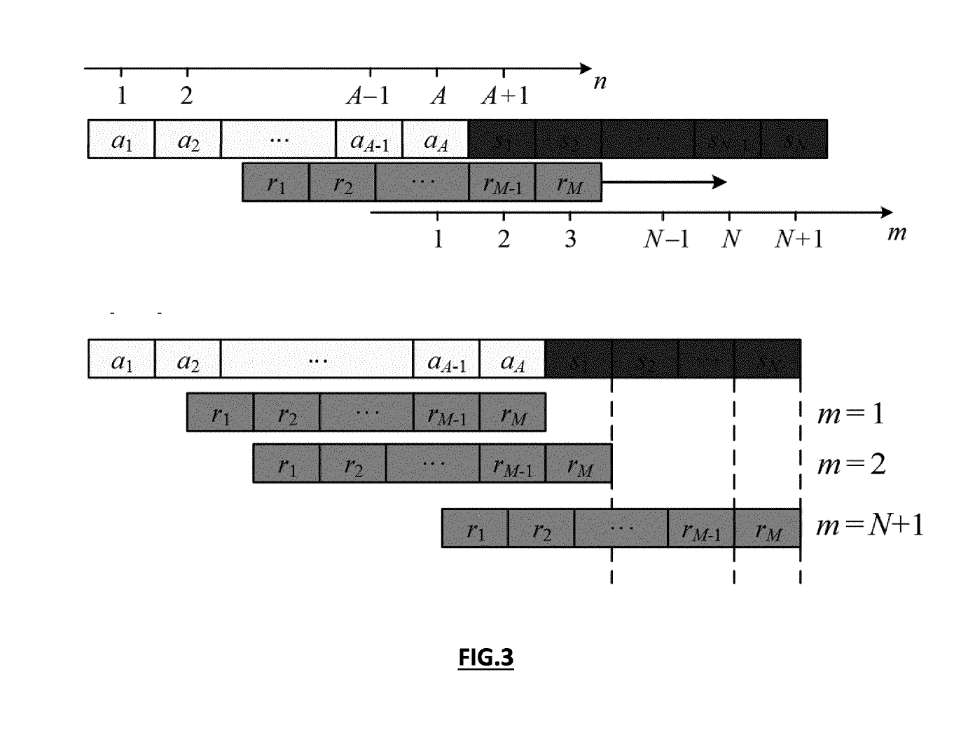

FIG. 3 illustrates the meaning of the index m, which determines the position of the sliding window (xₘ) relative to the position of the sync marker (s). The upper part (A) of FIG. 3 shows the indexing of sliding window position, while the lower part (B) illustrates some examples of sliding window positions, i.e., possible values of index m.

With the indexing of FIG. 3, the two hypotheses can be reformulated as:

H₀:mε{1, 2, . . . , N}

H₁:m=N+1

Table 1 shows the relation between indices n and m and the observed window (xₘ). The index m refers to the last symbol position of the sliding window (xₘ), counted from the last symbol of the acquisition sequence (a), whereas the index n refers to the first symbol of the sliding window (xₘ), counted from the start of the acquisition sequence (a). Both indices are related by the expression: n=A−M+m. Only window positions in which the sliding observation window (xₘ) ends before or at the same bit interval as the sync marker (s) are considered, and therefore the random data sequence (d) has no effect.

TABLE 1

| n | m | xₘ |
|---|---|---|
| $1 ⋯ A - M + 1$ | 1 | h₁ · a_{M} |
| A − M + 2 | 2 | [h₁ · a_{M-1}, h₂ · s₁] |
| A − M + 3 | 3 | [h₁ · a_{M-2}, h₂ · s₂] |
| $⋮$ | $⋮$ | $⋮$ |
| A − M + N | N | [h₁ · a_{M-N+1}, h₂ · s_{N-1}] |
| A − M + N + 1 | N + 1 | [h₁ · a_{M-N}, h₂ · s] |

The received signal (r) in the observation window (xₘ) is hence:

$$r = {x}_{m} + w , w \text{∼} ( 0 , \frac{{N}_{0}}{2} {I}_{M} )$$

One of the key aspects when considering the acquisition sequence (a) is that, in contrast to a sync marker (s) preceded by random data, the mixed data case cannot be neglected. For this reason, all positions of the observation window (xₘ) for the null hypothesis are considered.

For the null hypothesis,

$$p ( r \vert {H}_{0} ) = {\sum }_{µ = 1}^{N} {ρ}_{m} p ( r \vert m = µ ) , \qquad ( equation 15 )$$

where ρ_{μ}P[m=μ] denotes the a priori probability that the sliding window (xₘ) is in position m=μ, assuming that

$${ρ}_{µ} = \frac{1}{A + N - M - 1} \{ \begin{matrix}A - M for µ = 1 \\ 1 for µ = 2 , … , N\end{matrix}$$

and the same probability for the four sign ambiguities, i.e.

$$p ( r \vert m = µ ) = \frac{1}{4} {\sum }_{{h}_{1} , {h}_{2}} p ( r \vert m = µ , {h}_{1} , {h}_{2} )$$

then

$$\begin{matrix}p ( r \vert m , {h}_{1} , {h}_{2} ) = {\prod }_{n = 1}^{M - m + 1} p ( {r}_{n} \vert {x}_{mn} = {h}_{1} {a}_{n} ) \cdot \\ {\prod }_{n = M - m + 2}^{M} p ( {r}_{n} \vert {x}_{mn} = {h}_{2} {s}_{n - M + m - 1} ) \\ = {K}_{M} ( r ) \cdot {\prod }_{n = 1}^{M - m + 1} exp ( {h}_{1} {a}_{n} {\tilde{r}}_{n} ) \cdot \\ {\prod }_{n = M - m + 2}^{M} exp ( {h}_{2} {s}_{n - M + m - 1} {\tilde{r}}_{n} )\end{matrix}$$

and with \tilde{r}ₙ^{m} [symbol] [\tilde{r}ₙ, \tilde{r}ₙ₊₁, . . . , \tilde{r}ₘ], we can write

p(r|m,h₁,h₂)=K_{M}·exp(h₁\tilde{r}₁^{M-m+1}a_{M-m+1}^{T})·exp(h₂\tilde{r}_{M-m+2}^{M}sₘ₋₁^{T})

and hence

$$p ( r \vert m ) = {K}_{M} \cdot cosh ( {\tilde{r}}_{1}^{M - m + 1} {a}_{M - m + 1}^{T} ) \cdot cosh ( {\tilde{r}}_{M - m + 2}^{M} {s}_{m - 1}^{T} )$$

$$and$$

$$p ( r \vert {H}_{0} ) = {K}_{M} {\sum }_{m = 1}^{N} {ρ}_{m} cosh ( {\tilde{r}}_{1}^{M - m + 1} {a}_{M - m + 1}^{T} ) \cdot cosh ( {\tilde{r}}_{M - m + 2}^{M} {s}_{m - 1}^{T} )$$

For the other hypothesis, we obtain

p(r|H₁)=K_{M}·cos h(\tilde{r}₁^{M-N}a_{M-N}^{T})·cos h(\tilde{r}_{M-N+1}^{M}s^{T})

which leads to a metric of likelihood ratio test for the acquisition sequence, LRT-A,—the “A” stands for the acquisition sequence (a)—in logarithmic domain:

$${Λ}_{LRT - A} ( r ) = ln cosh ( {\tilde{r}}_{1}^{M - N} {a}_{M - N}^{T} ) + ln cosh ( {\tilde{r}}_{M - N + 1}^{M} {s}^{T} ) - ln {\sum }_{m = 1}^{N} {ρ}_{m} cosh ( {\tilde{r}}_{1}^{M - m + 1} {a}_{M - m + 1}^{T} ) \cdot cosh ( {\tilde{r}}_{M - m + 2}^{M} {s}_{m - 1}^{T} )$$

This expression simplifies slightly for M=N, but does not become identical to the equation 8 described in prior-art. The difference comes from the fact that here the mixed data case is explicitly taken into account.

The application of the standard LRT can lead to two types of error at every symbol position:
i) a false alarm occurs if the presence of the sync marker (s) is indicated by Λ(r)≥λ at another position than the true one,
ii) a missed detection occurs if the observation window (xₘ) is at the true position but the metric Λ(r) is below the threshold λ.

These error events can be distinguished by the window position given by the index n shown in Table 1. The probabilities for false alarm P_{fa}(v) and missed detection P_{md} are respectively given by

P_{fa}(v)=P[Λ≥λ, n=v], v=1, . . . , A−M+N

P_{md}=P[Λ<λ, m=N+1] (equation 16)

For the overall false alarm probability P̅_{fa}, since the events {n=1}, {n=2}, . . . , {n=A−M+N} are mutually exclusive, we have

$${\overline{P}}_{fa} = {\sum }_{v = 1}^{A - M + N} {P}_{fa} ( v ) \qquad ( equation 17 )$$

Since in each failed synchronization attempt, either a false alarm or a missed detection occurs, the probability of a frame synchronization error, FSE, is hence given by the sum of both probabilities

P_{FSE}=P̅_{fa}+P_{md} (equation 18)

The proposed methods are validated through computer simulations in the deep-space communication uplink and show significant performance gains compared to current solutions.

In the following, the system parameters for deep space telecommand in the uplink are used as a running example, being the most important aspect the length (N) of the sync marker (s). The sync marker (s) is defined in hexadecimal notation by the ECSS as the word EB90 and has a length of N=16 bits. For the acquisition sequence (a), the length (A) which is assumed in the example is A=512.

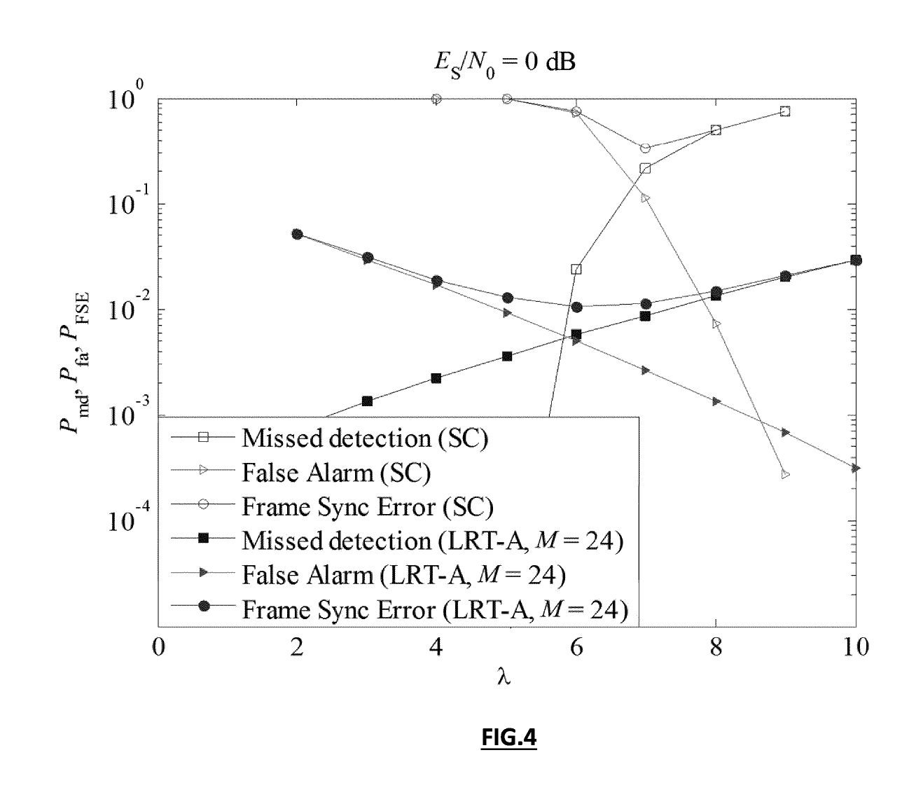

FIG. 4 shows missed detection, false alarm and frame synchronization error probabilities as a function of the detection threshold for the soft correlation (SC) and the LRT-A metrics with a length of extended observation window M=24. In FIG. 4, the false alarm and missed detection probabilities, denoted as P̅_{fa} and P_{md} respectively, as well as the resulting frame synchronization error—FSE—probability P_{FSE}, are plotted as a function of the decision threshold λ for two metrics at E_{S}/N₀=0 dB. From the definition of the standard LRT, it is clear that the false alarm probability P̅_{fa} is a decreasing function of the threshold λ, while the missed detection probability P_{md} is increasing. The parameter of interest, however, is the FSE, which simplifies the problem of finding the optimum threshold to a simple one-dimensional minimization which can be solved numerically by simulation.

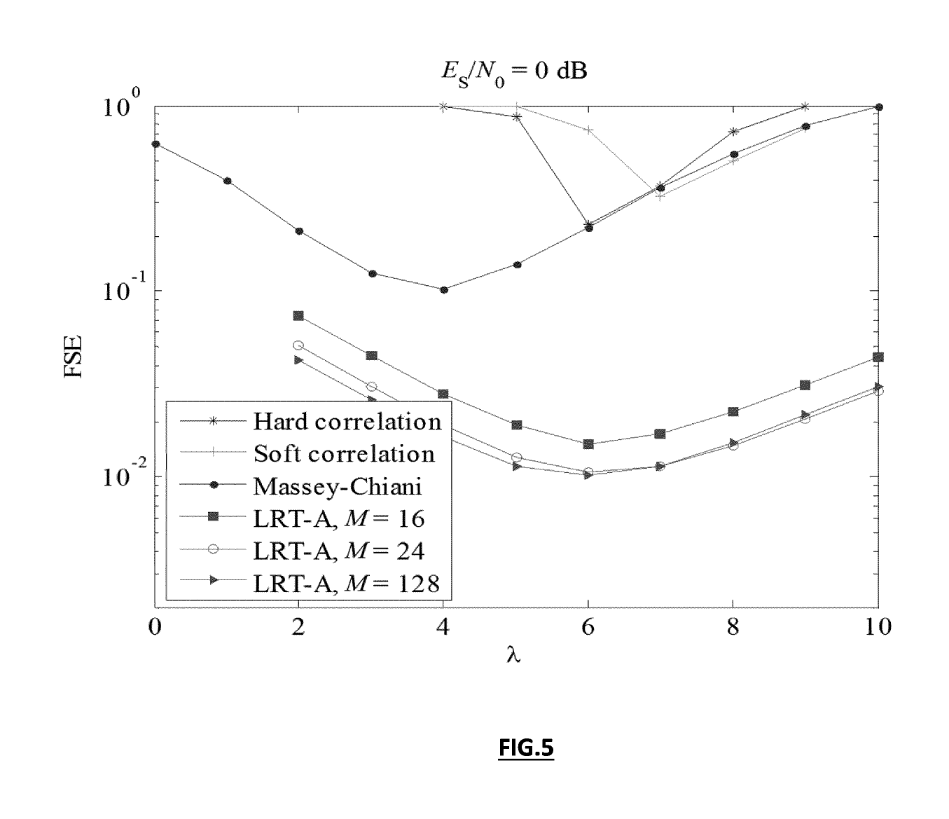

FIG. 5 shows the frame synchronization error (FSE) values at a fixed SNR, e.g., Es/N₀=0, and for every metric which is considered here: Hard and Soft correlations, the Massey-Chiani metric and LRT-A for different lengths (M) of the extended sliding window, and the FSE is plotted as a function of the decision threshold λ. From these diagrams, the optimum threshold for each metric for a given SNR can be found. These values of the optimum decision threshold A for minimum FSE are listed in Table 2 for the four metrics and for several SNR values, in terms of energy per symbol to noise power spectral density ratio (Es/N₀).

TABLE 2

| | Hard | Soft | Massey- | |
|---|---|---|---|---|
| E_{S}/N₀ | Correlation | Correlation | Chiani | LRT-A |
| −3 dB | 6 | 9 | 5 | 6 |
| −2 dB | 6 | 8 | 4 | 6 |
| −1 dB | 6 | 7 | 4 | 6 |
| 0 dB | 6 | 7 | 4 | 6 |
| 1 dB | 6 | 6 | 3 | 6 |
| 2 dB | 6 | 6 | 2 | 6 |
| 3 dB | 6 | 6 | 1 | 6 |
| 4 dB | 6 | 6 | 0 | 6 |

From FIG. 5 and Table 2, it can be derived that, at least within this range, only the SC and the MC metrics depend on the SNR, while for the HC and the LRT-A the same threshold can be applied for all SNR values. This aspect is important in practical receivers where an accurate SNR estimation is often not viable.

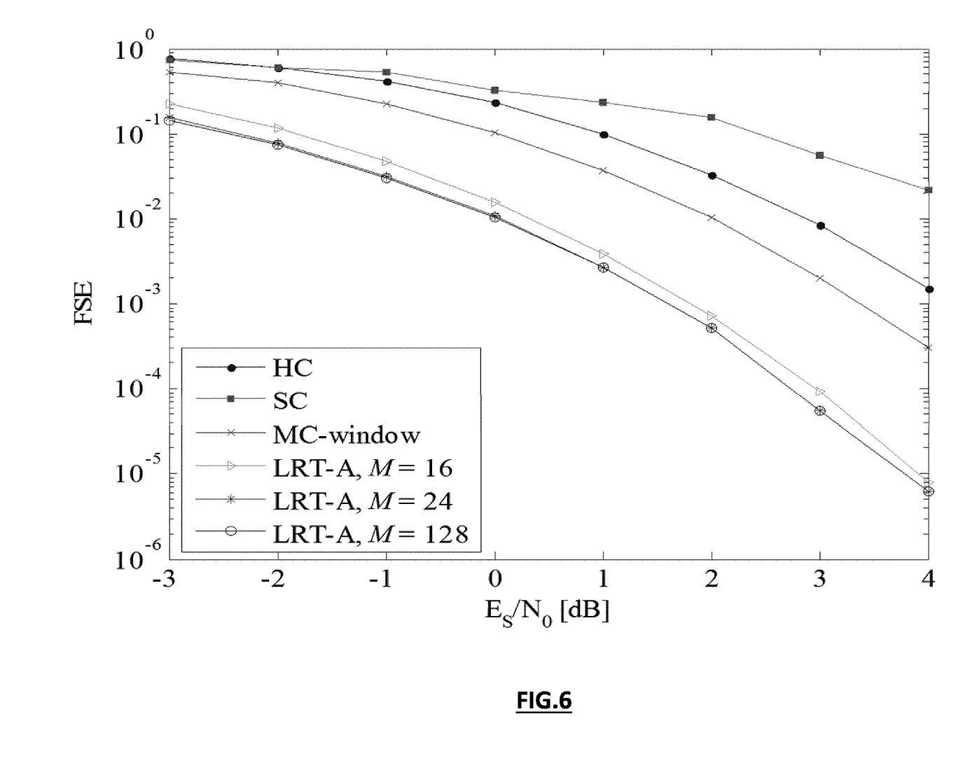

FIG. 6 shows the achieved frame synchronization error (FSE) values for different values of SNR and for every metric which is considered here: Hard and Soft correlations, the Massey-Chiani metric and LRT-A for different lengths (M) of the extended sliding window, and the FSE is plotted as a function of the energy per symbol to noise power spectral density ratio (Es/N₀). We can observe that, while soft correlation performs very poorly, the hard correlation metric comes comes close to the Massey-Chiani metric for high SNR. We can also see that the proposed LRT-A metric achieves a significant performance improvement for all SNR values, even without extending the window length. This gain comes from the exploitation of the structure of the acquisition sequence, in particular in the mixed data case. The performance improves slightly by extending the observation window from 16 to 24 bits, while a further extension to 128 bits does not lead to a further improvement.

In an alternative embodiment of the invention, the proposed method for frame syncronization uses, single or multiple, peak detection with a long observation window, i.e. a buffer of length B»N, where N is the length of the syncronization marker (s).

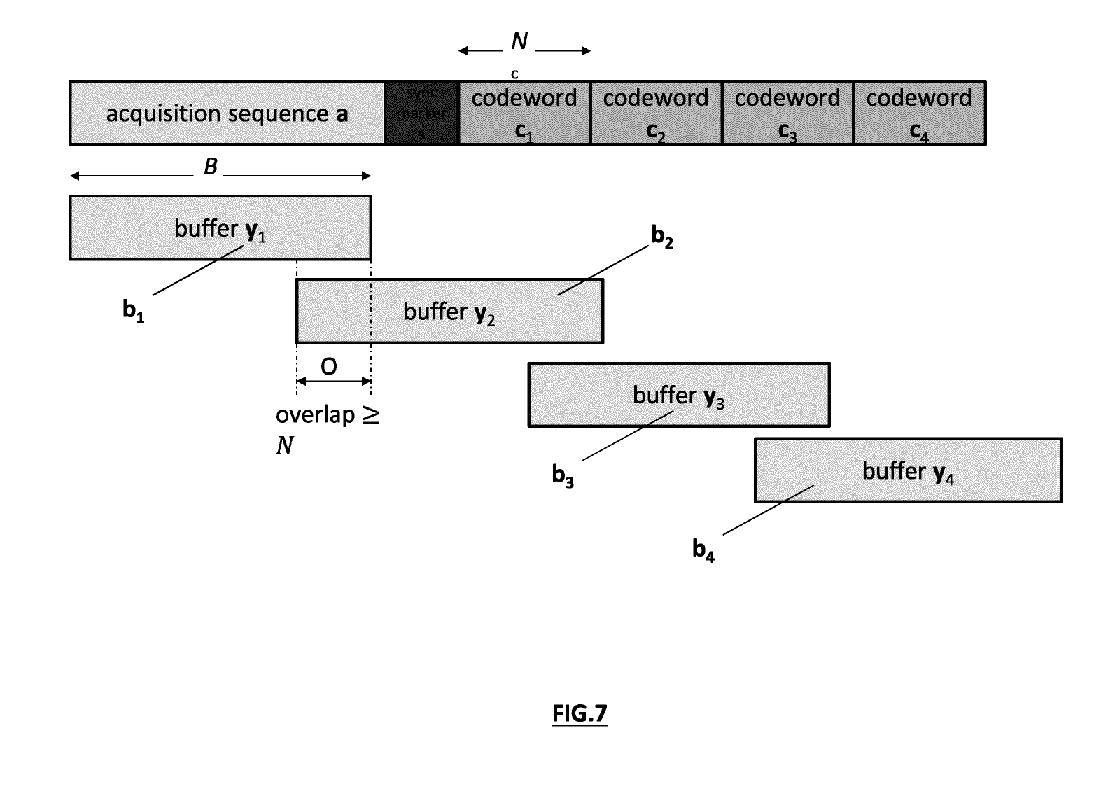

For single or multiple peak detection based on the long observation window, a further assumption on the frame structure is that the sync marker (s) is followed by one or multiple codewords (c₁, c₂, . . . ) as depicted in FIG. 7. The incoming symbols stream is partitioned into overlapping sequences (b₁, b₂, . . . ) of length B»N, which are buffered in storing means of the receiver at respective buffer positions (y₁, y₂, . . . ). The overlap (O) comprises at least N−1 symbols, in order to avoid that the sync marker (s) falls between two consecutive buffer positions.

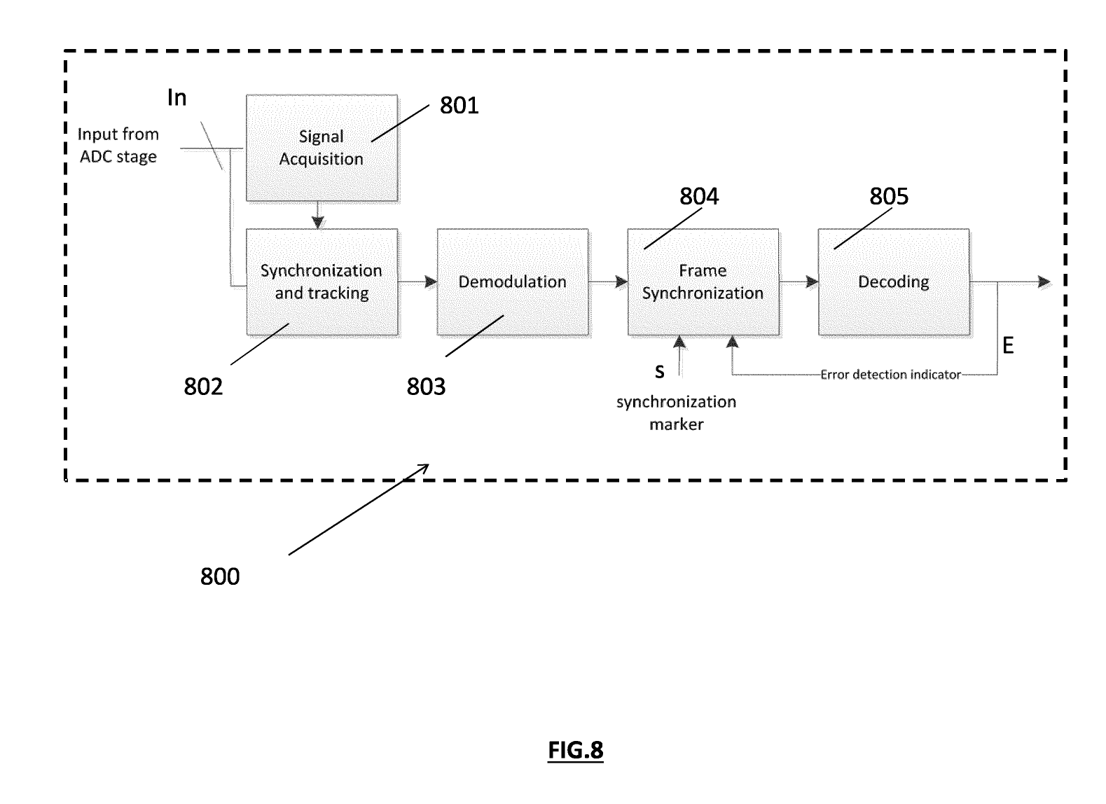

On the other hand, a condition which is given in many communication systems is that, at the receiving side, a channel decoder is capable to determine if a sequence of N, symbols corresponds to the first codeword after the sync marker (s). This is used in a possible embodiment of the invention to avoid false alarms, that is, to avoid that the frame synchronizer declares a sync marker detection although no sync marker is present. In this case, an error detection indicator needs to be available to the frame synchronizer. An illustrative example of a possible receiver (800) block diagram is depicted in FIG. 8. The input signal (In) from the ADC stage is processed by the signal adquisition (801) and the synchronization and tracking means (802) of the receiver (800). The, the adquired signal is demoduled and decoded, but it is needed a frame synchronizer (804) between the demodulator (803) and the decoder (805). The proposed frame synchronizer (804) uses the sync marker (s) and indicators (E) of the error detection by the decoder (805).

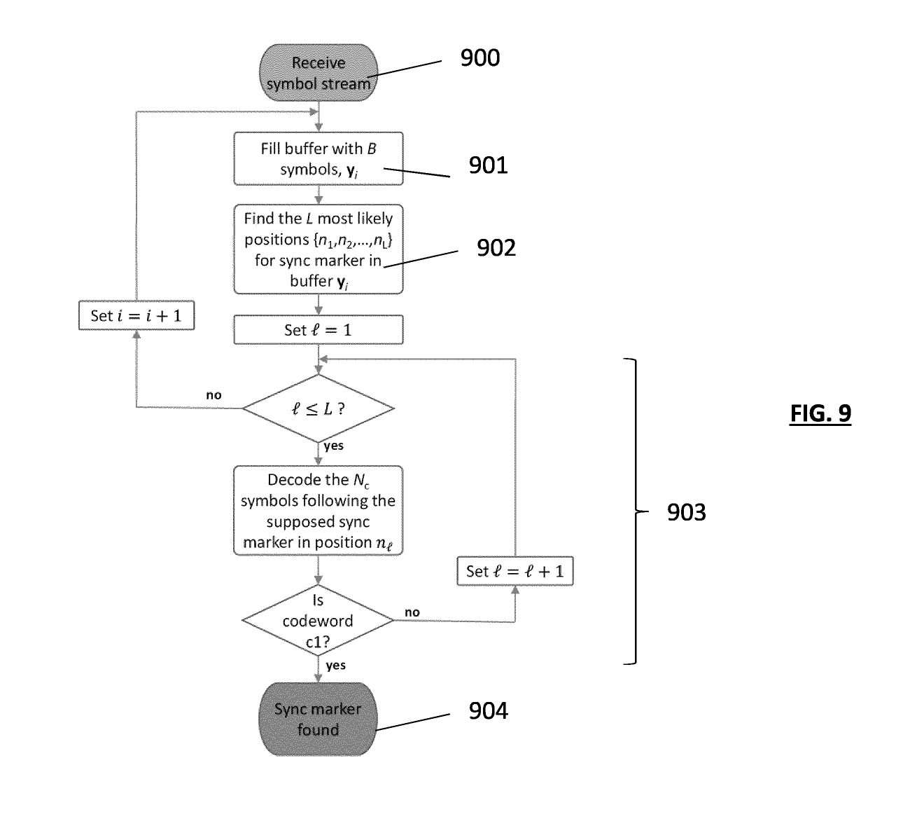

FIG. 9 illustrates the procedure of applying (multiple) peak detection using the long observation window determined by a buffer of length B. The buffer positions (yᵢ) are filled (901) with symbols (b₁, b₂, . . . ) of length B from the received stream (900). Then, the most likely positions (n₁, n₂, . . . , n_{L}) of the sync marker (s) are searched (902) in the buffer positions (yᵢ), as explained below. The channel decoder (805) decodes (903′) the N_{c} symbols which follow a candidate sync marker. For each candidate position, the channel decoder (805) checks (903) if the N_{c} symbols which follow the candidate sync marker correspond to a codeword (c₁, c₂, . . . ). If this is the case, the correct position is found (904). If not, the next candidate position is tested and if no valid codeword is found after testing all candidate positions, the search continues with the content of the next buffer.

While for one-shot detection of the sync marker (s), for every window position (m), a metric is compared to a threshold, as disclosed by Chiani in “Noncoherent frame synchronization,” for periodically inserted sync markers (s) with known periodicity, the receiver can search for the maximum metric within a frame by single peak detection and then there is no need to determine any threshold as disclosed by Massey in “Optimum frame synchronization”.

Nevertheless, peak detection even for a single sync marker can be applied with the following method: The incoming symbol stream is partitioned into long overlapping observation windows. The overlap is as long as the sync marker to avoid that this falls in between two windows. Then, peak detection is applied within the long observation window. This inevitably leads to false alarms in windows which do not contain the sync marker (s). These false alarms can be detected after decoding of the first code word after the sync marker (s), provided that the undetected error probability of the channel coding scheme is lower than the target FSE. This is an additional requirement which, however, is typically satisfied anyway.

It is assumed that the long observation window contains B=A+N+D»N symbols and contains the acquisition sequence (a), the sync marker (s) and data (d), as depicted in FIG. 1. The entire noiseless sequence in the buffer of length B is given in equation 13 and the received sequence is denoted by y=x+x. The maximum likelihood rule to determine the index of the first bit of the sync marker (s) is given by:

$${n}^{*} = arg {max}_{m} \{ p ( y \vert A = m ) \} + 1$$

Similar to the derivation for the extended observation window, we start with p(y|A=m)=1/4Σₕ_{₁}_{,h}_{₂}p(y|A=m,h₁,h₂). Since we are considering the entire buffer, we factor the conditional probability of y as

$$\begin{matrix}p ( y \vert m , {h}_{1} , {h}_{2} ) = {\prod }_{n = 1}^{m} p ( {y}_{n} \vert {h}_{1} {a}_{n} ) \cdot {\prod }_{n = m + 1}^{m + N} p ( {y}_{n} \vert {h}_{2} {s}_{n - m} ) \cdot \\ {\prod }_{n = m + N + 1}^{B} \frac{p ( {y}_{n} \vert - 1 ) + p ( {y}_{n} \vert 1 )}{2} \\ = {K}_{B} ( y ) \cdot exp ( {h}_{1} {\tilde{y}}_{1}^{m} {a}_{m}^{T} ) \cdot exp ( {h}_{2} {\tilde{y}}_{m + 1}^{m + N} {s}^{T} ) \cdot {\prod }_{n = m + N + 1}^{B} cosh ( {\tilde{y}}_{n} )\end{matrix}$$

which leads to

$$p ( y \vert A = m ) = {K}_{B} \cdot cosh ( {\tilde{y}}_{1}^{m} {a}_{m}^{T} ) \cdot cosh ( {\tilde{y}}_{m + 1}^{m + N} {s}^{T} ) \cdot {\prod }_{n = m + N + 1}^{B} cosh ( {\tilde{y}}_{n} )$$

and, finally, the metric to be maximized Λ_{LW(m)} is defined as

$$\begin{matrix}{Λ}_{LW} ( m ) {=}^{Δ} ln ( \frac{1}{{K}_{B}} p ( y \vert A = m ) ) \\ = ln cosh ( {\tilde{y}}_{1}^{m} {a}_{m}^{T} ) + ln cosh ( {\tilde{y}}_{m + 1}^{m + N} {s}^{T} ) + {\sum }_{n = m + N + 1}^{B} ln cosh ( {\tilde{y}}_{n} )\end{matrix}$$

The most likely position of the first symbol of the sync marker (s) is then found by:

$${n}^{*} = arg {max}_{m} \{ {Λ}_{LW} ( m ) \} + 1$$

In another possible embodiment of the invention, multiple peak detection on the long observation window can be used for frame syncronization. The fact that the sync marker (s) is followed by codewords can be further exploited, in the case that the code schema which is used provides sufficient error detection capability and multiple decoding attempts are affordable. These are rather mild assumptions, since the probability of undetected error is usually required to be significantly lower than the FSE. Furthermore, bit rates for telecommand operations are typically moderate, hence multiple decoding attempts within the observation window, which is at least as long as a codeword, are not unrealistic.

For multiple peak detection, the indices nε{1, 2, . . . , B} are listed in decreasing metric order:

Λ_{LW}(m₁)≥Λ_{LW}(m₂)≥ . . . ≥Λ_{LW}(m_{B})

and perform L successive decoding attempts for the indices m₁, m₂, . . . , m_{L}. In coding theory, this approach is known as list decoding.

For L=1, we have the simple peak detection as described before, while for the unrealistic value L=B, the FSE is limited only by the undetected word error probability of the channel coding scheme.

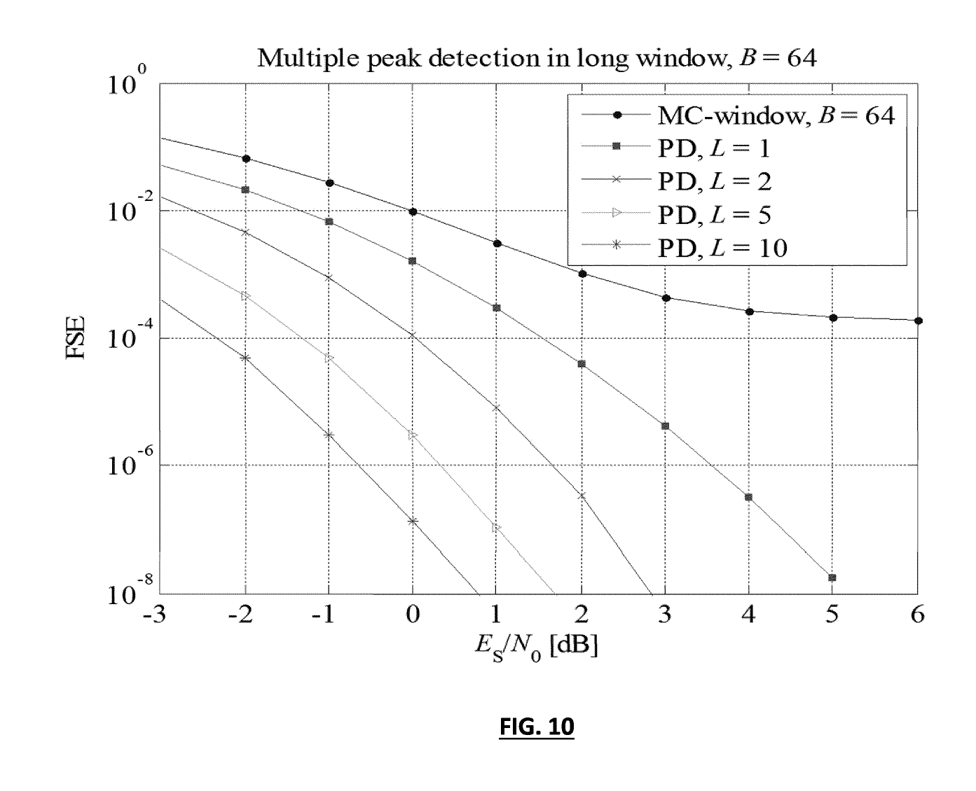

FIG. 10 shows the achieved FSE with multiple peak detection (PD) for different list decoding lengths L. A short value of additional decoding attempts already provides very significant gains for frame synchronization. As a reference, the Massey-Chiani (MC) metric can also be applied, computed in a sliding window operation and with buffer of length B=64, but this MC metric suffers from an error floor which is due to false alarms which are unavoidable if the 16-bit sync marker appears in the data.

The proposed embodiments can be implemented as a collection of software elements, hardware elements, firmware elements, or any suitable combination of them.

Note that in this text, the term “comprises” and its derivations (such as “comprising”, etc.) should not be understood in an excluding sense, that is, these terms should not be interpreted as excluding the possibility that what is described and defined may include further elements, steps, etc.

1. A method for frame synchronizing in communication systems, the method comprising:
receiving a frame that comprises a data sequence, a synchronization marker preceding the data sequence, and an acquisition sequence preceding the synchronization marker; and
searching for the synchronization marker by using the acquisition sequence.

2. The method according to claim 1, wherein the synchronization marker has a first length, and the searching for the synchronization marker further comprises using a sliding observation window with a second length, where the second length is equal to or greater than the first length.

3. The method according to claim 2, wherein the frame is transmitted in a signal out of a J-PSK constellation, where J≥2.

4. The method according to claim 2, further comprising:
computing a metric of likelihood ratio test the acquisition sequence, LRT-A, which is compared to a pre-defined threshold to determine whether a sequence received in the sliding observation window is the synchronization marker,
wherein the metric of likelihood ratio test for the acquisition sequence, denoted by Λ_{LRT-A}(r), is computed as:
$${Λ}_{LRT - A} ( r ) = ln cosh ( {\tilde{r}}_{1}^{M - N} {a}_{M - N}^{T} ) + ln cosh ( {\tilde{r}}_{M - N + 1}^{M} {s}^{T} ) - ln {\sum }_{m = 1}^{N} {ρ}_{m} cosh ( {\tilde{r}}_{1}^{M - m + 1} {a}_{M - m + 1}^{T} ) \cdot cosh ( {\tilde{r}}_{M - m + 2}^{M} {s}_{m - 1}^{T} )$$
where the synchronization marker, s=[s₁, s₂, . . . , s_{N}], N denoting the length of the synchronization marker,
the received sequence in the sliding observation window is denoted by a vector r, r=[r₁, r₂, . . . , r_{N}], and the acquisition sequence is denoted by a vector a.

5. The method according to claim 1, wherein the synchronization marker has a first length, and the searching for the synchronization marker further comprises:
finding a most likely position of the synchronization marker first symbol by detecting at least one peak in a sequence of symbols from the received frame, the sequence being received in a buffer having first buffer length greater than the first length.

6. The method according to claim 5, wherein detecting one peak in the sequence received in the buffer comprises computing a metric Λ_{LW}(m) as
$${Λ}_{LW} ( m ) = ln cosh ( {\tilde{y}}_{1}^{m} {a}_{m}^{T} ) + ln cosh ( {\tilde{y}}_{m + 1}^{m + N} {s}^{T} ) + {\sum }_{n = m + N + 1}^{B} ln cosh ( {\tilde{y}}_{n} )$$
where the sequence received in the buffer is denoted by y=[y₁, y₂, . . . , y_{B}],
the synchronization marker is denoted by s=[s₁, s₂, . . . , s_{N}], the acquisition sequence is denoted by a=[a₁, a₂, . . . , a_{A}], and
m denotes a position of the synchronization marker first symbol;
and finding the most likely position of the synchronization marker first symbol comprises maximizing the computed metric.

7. The method according to claim 6, further comprising:
listing in decreasing order the computed metric Λ_{LW}(m) for every possible value of m from a set of indices nε{1, 2, . . . , B} to obtain a list, Λ_{LW}(m₁)≥Λ_{LW}(m₂)≥ . . . ≥Λ_{LW}(m_{B}), and performing list decoding over the list.

8. The method according to claim 5, further comprising decoding a set of symbols from the sequence received in the buffer, and
applying error detection to the decoded symbols to avoid false dectections of the synchronization marker.

9. The method according to claim 1, wherein the acquisition sequence is selected from a sequence of alternating binary symbols, a sequence of zeros and a constant signal.

10. A frame synchronizer device for a receiver of a communication system, the receiver receiving a frame which comprises a data sequence, a synchronization marker preceding the data sequence and an acquisition sequence preceding the synchronization marker, the device by comprising:
a searcher circuit configured to search the synchronization marker by using the acquisition sequence.

11. The device according to claim 10, wherein the searcher circuit is configured to use a sliding observation window with a second length greater than or equal to a length of the synchronization marker.

12. The device according to claim 11, further comprising metric computing instructions configured to compute a metric of likelihood ratio test the acquisition sequence, LRT-A, which is compared to a pre-defined threshold to determine whether a sequence received in the sliding observation window is the synchronization marker,
wherein the metric of likelihood ratio test for the acquisition sequence denoted by Λ_{LRT-A}(r), is computed as:
$${Λ}_{LRT - A} ( r ) = ln cosh ( {\tilde{r}}_{1}^{M - N} {a}_{M - N}^{T} ) + ln cosh ( {\tilde{r}}_{M - N + 1}^{M} {s}^{T} ) - ln {\sum }_{m = 1}^{N} {ρ}_{m} cosh ( {\tilde{r}}_{1}^{M - m + 1} {a}_{M - m + 1}^{T} ) \cdot cosh ( {\tilde{r}}_{M - m + 2}^{M} {s}_{m - 1}^{T} )$$
where the synchronization marker, s=[s₁, s₂, . . . , s_{N}], N denoting the length of the synchronization marker,
the received sequence in the sliding observation window is denoted by r, r=[r₁, r₂, . . . , r_{N}], and
the acquisition sequence a=[a₁, a₂, . . . , a_{A}], A denoting the length of the acquisition sequence.

13. The device according to claim 10, wherein the searcher circuit comprises a buffer of a first buffer length greater than a length of the synchronization marker length, and
wherein the searcher circuit applies a peak detector to a sequence of symbols received in the buffer to find a most likely position of the synchronization marker first symbol and error detection indicators from a decoder of the receiver to avoid false dectections of the synchronization marker.

14. The device according to claim 13, wherein the peak detector comprises metric computing instructions configured to compute a metric Λ_{LW}(m) as
$${Λ}_{LW} ( m ) = ln cosh ( {\tilde{y}}_{1}^{m} {a}_{m}^{T} ) + ln cosh ( {\tilde{y}}_{m + 1}^{m + N} {s}^{T} ) + {\sum }_{n = m + N + 1}^{B} ln cosh ( {\tilde{y}}_{n} )$$
where the sequence received in the buffer is denoted by y=[y₁, y₂, . . . , y_{B}],
the synchronization marker is denoted by s=[s₁, s₂, . . . , s_{N}], the acquisition sequence is denoted by a=[a₁, a₂, . . . , a_{A}], and
m denotes a position of the synchronization marker (s) first symbol; and
the peak detector finds the most likely position of the synchronization marker first symbol by maximizing the computed metric.

15. The device according to claim 14, further comprising a list decoder applied to a list of the computed metric Λ_{LW}(m) values, obtained in decreasing order for every possible position m from a set of indices nε{1, 2, . . . , B}.
